(19) United States
(12) Patent Application Publication
(10) Pub. No.: US 2025/0297600 A1
(43) Pub. Date: Sep. 25, 2025

(54) Back-Worn Air Compressor Device

(71) Applicant: Robert Emery, New Castle, PA (US)

(72) Inventor: Robert Emery, New Castle, PA (US)

(21) Appl. No.: 19/074,592

(22) Filed: Mar. 10, 2025

Related U.S. Application Data
(60) Provisional application No. 63/568,004, filed on Mar. 21, 2024.

(51) Int. Cl. F04B 17/06; B25F 5/00; F04D 25/06; F16M 13/04

(52) U.S. Cl. CPC F04B 17/06; F04D 25/0673; F16M 13/04; B25F 5/00

(57) ABSTRACT

A back-worn air compressor device is provided. The device is designed to provide a portable, battery-powered source of pressurized air for pneumatic tools without reliance on stationary compressors or external power supplies. The device is comprised of a body-worn frame that supports at least one air tank and compressor assembly, with an adjustable harness system that evenly distributes weight to reduce fatigue. A dual-stage compressor mechanism with an intercooler, low-noise motor, and automatic pressure control ensures reliable airflow. The compressor assembly is further powered by a removable lithium-ion battery pack featuring a charge status indicator and charging port.

### CROSS-REFERENCE TO RELATED APPLICATION

The present application claims priority to, and the benefit of, U.S. Provisional Application No. 63/568,004, which was filed on Mar. 21, 2024, and is incorporated herein by reference in its entirety.

### FIELD OF THE INVENTION

The present invention relates generally to the field of air compressors. More specifically, the present invention relates to a back-worn air compressor device that provides a portable body-worn air compressor. Accordingly, the present disclosure makes specific reference thereto. Nonetheless, it is to be appreciated that aspects of the present invention are also equally applicable to other like applications, devices, and methods of manufacture.

### BACKGROUND

Traditional air compressors are often large, stationary, and require an external power source, limiting their portability and practicality in various work environments. Professionals who rely on pneumatic tools, such as construction workers, automotive technicians, and industrial maintenance personnel, frequently encounter challenges when working in remote locations or confined spaces where access to a stationary air compressor is impractical. The reliance on long air hoses and extension cords can lead to inefficiencies, reduced mobility, and potential safety hazards, including tripping risks and restricted movement. Additionally, conventional air compressors generate significant noise and heat, which may not be suitable for indoor or noise-sensitive work environments. Workers who require a reliable compressed air source often face difficulties managing air pressure levels, hose connections, and moisture buildup within the air tank, which can impact tool performance and longevity. Furthermore, the weight and bulk of traditional compressors can contribute to worker fatigue, reducing productivity over extended periods of use. These limitations highlight the need for a more portable and efficient compressed air solution that maintains performance while improving user comfort and mobility.

Therefore, there exists a long-felt need in the art for a back-worn air compressor device that provides a portable and self-contained source of compressed air without requiring stationary equipment or external power sources. There also exists a long-felt need in the art for a back-worn air compressor device that reduces worker fatigue by incorporating an ergonomic harness system that evenly distributes weight and enhances comfort. Moreover, there exists a long-felt need in the art for a back-worn air compressor device that improves workplace efficiency and safety by minimizing reliance on long air hoses, extension cords, and bulky equipment.

The subject matter disclosed and claimed herein, in one embodiment thereof, comprises a back-worn air compressor device. The device is designed to provide a portable, battery-powered source of pressurized air for pneumatic tools without reliance on stationary compressors or external power supplies. The device is comprised of a body-worn frame that supports at least one air tank and compressor assembly, with an adjustable harness system that evenly distributes weight to reduce fatigue. A dual-stage compressor mechanism with an intercooler, low-noise motor, and automatic pressure control ensures reliable airflow. The compressor assembly is further powered by a removable lithium-ion battery pack featuring a charge status indicator and charging port.

In this manner, the back-worn air compressor device of the present invention accomplishes all the forgoing objectives and provides a wearable, battery-powered compressed air solution that enhances mobility and convenience. Furthermore, the battery powers the compressor assembly, ensuring a consistent supply of pressurized air without dependence on external power. By eliminating the constraints of traditional compressors, the back-worn air compressor device improves productivity, safety, and ease of use for professionals who require a reliable and portable compressed air source.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a back-worn air compressor device. The back-worn air compressor device is a wearable, battery-powered system designed to supply pressurized air to pneumatic tools without reliance on stationary compressors or external power sources. The device is comprised of a frame supporting at least one air tank and a compressor assembly. The frame includes an adjustable harness system with padded shoulder straps to evenly distribute weight and reduce fatigue.

The air tank ensures a consistent air supply and includes a pressure regulator for adjustable output. A quick-connect fitting allows the attachment of air hoses, and a pressure gauge provides real-time pressure readings. A bottom-mounted drain plug facilitates moisture removal to prevent internal corrosion.

The compressor assembly features a dual-stage compression mechanism for enhanced efficiency and stable pressure. An intercooler dissipates heat between stages, and a low-noise motor minimizes sound output. An automatic on/off pressure switch optimizes energy use, while a pressure cut-off mechanism prevents over-pressurization. A waterproof housing protects internal components, incorporating vents or passive cooling for thermal regulation. Power is supplied by a removable high-capacity lithium-ion battery pack, which includes a status indicator for charge monitoring and a charging port for recharging.

A method of using the device includes securing the device with the harness system, connecting a pneumatic tool to the quick-connect fitting, adjusting the pressure regulator, activating the compressor assembly via a control button, and replacing or recharging the battery as needed. After use, accumulated moisture can be drained from the air tank via the bottom-mounted plug.

Accordingly, the back-worn air compressor device of the present invention is particularly advantageous as it provides a wearable, battery-powered compressed air solution that enhances mobility and convenience. Furthermore, the battery powers the compressor assembly, ensuring a consistent supply of pressurized air without dependence on external power. By eliminating the constraints of traditional compressors, the back-worn air compressor device improves productivity, safety, and ease of use for professionals who require a reliable and portable compressed air source. In this manner, the back-worn air compressor device overcomes the limitations of existing air compressors known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front view of one potential embodiment of a back-worn air compressor device of the present invention in accordance with the disclosed architecture;

FIG. 2 illustrates a rear view of one potential embodiment of a back-worn air compressor device of the present invention in accordance with the disclosed architecture;

FIG. 3 illustrates a flowchart of a method of using one potential embodiment of a back-worn air compressor device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a back-worn air compressor device that provides a portable and self-contained source of compressed air without requiring stationary equipment or external power sources. There also exists a long-felt need in the art for a back-worn air compressor device that reduces worker fatigue by incorporating an ergonomic harness system that evenly distributes weight and enhances comfort. Moreover, there exists a long-felt need in the art for a back-worn air compressor device that improves workplace efficiency and safety by minimizing reliance on long air hoses, extension cords, and bulky equipment.

The present invention, in one exemplary embodiment, is comprised of a back-worn air compressor device. The back-worn air compressor device is a wearable, battery-powered system that supplies pressurized air to pneumatic tools without requiring stationary compressors or external power sources. It is comprised of a frame that supports at least one air tank and a compressor assembly. The frame includes an adjustable harness system with padded shoulder straps to distribute weight evenly and reduce fatigue.

The air tank provides a steady air supply and features a pressure regulator for adjustable output. A quick-connect fitting enables the attachment of air hoses, while a pressure gauge offers real-time pressure monitoring. A bottom-mounted drain plug allows for moisture removal, preventing internal corrosion.

The compressor assembly incorporates a dual-stage compression mechanism for improved efficiency and stable pressure. An intercooler dissipates heat between stages, and a low-noise motor reduces sound output. An automatic on/off pressure switch optimizes energy consumption, while a pressure cut-off mechanism prevents over-pressurization. A waterproof housing shields internal components and includes vents or passive cooling for thermal regulation. Power is provided by a removable high-capacity lithium-ion battery pack, which features a status indicator for charge monitoring and a charging port for recharging.

The method of using the device involves securing the device with the harness system, connecting a pneumatic tool to the quick-connect fitting, adjusting the pressure regulator, activating the compressor assembly using a control button, and replacing or recharging the battery as necessary. Moisture can be drained from the air tank through the bottom-mounted plug after use.

As a result, the back-worn air compressor device offers a portable, battery-powered compressed air solution that enhances mobility and convenience. The battery-driven compressor ensures a continuous supply of pressurized air without reliance on external power. By removing the limitations of traditional compressors, this device improves productivity, safety, and ease of use for professionals requiring a dependable and portable compressed air source.

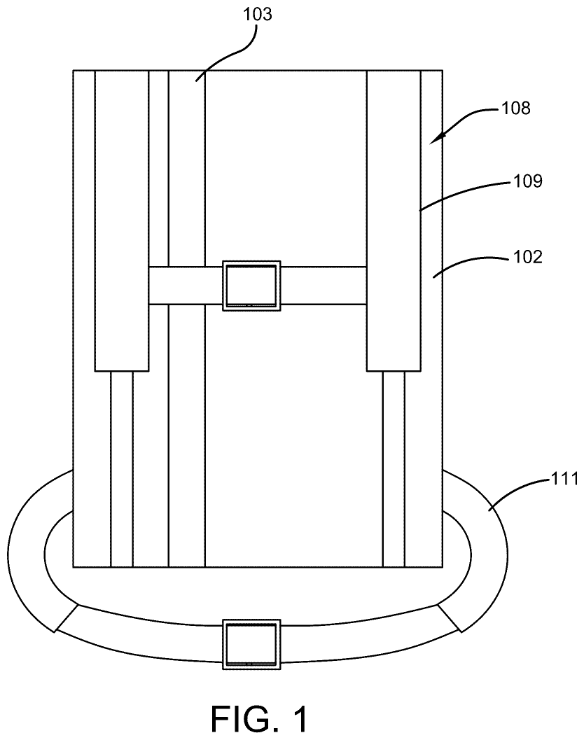

Referring initially to the drawings, FIG. 1 illustrates a front view of one potential embodiment of a back-worn air compressor device 100 of the present invention in accordance with the disclosed architecture. The back-worn air compressor device 100 is a wearable, battery-powered air compressor designed to provide pressurized air to pneumatic tools without relying on stationary air compressors or external power sources.

The device 100 is comprised of a frame 102 that supports at least one air tank 104 and at least one compressor assembly 106. In the preferred embodiment, the device 100 is worn on the user's back. In this embodiment, the frame 102 is comprised of an adjustable harness system 108 (as seen in FIG. 1) that distributes weight evenly across the user's back and shoulders, reducing fatigue. The harness system 108 may include padded, adjustable shoulder straps 109. Additionally, an optional waist belt 111 may be included to further stabilize the device 100 and shift some of the weight to the user's hips. The frame 102 may also be comprised of airflow channels 103 (as seen in FIG. 1) that promote ventilation, preventing heat buildup against the user's back and improving overall wearability. The airflow channels 103 may be formed by strategically placed openings or by integrating a mesh or perforated material into the back panel of the frame 102.

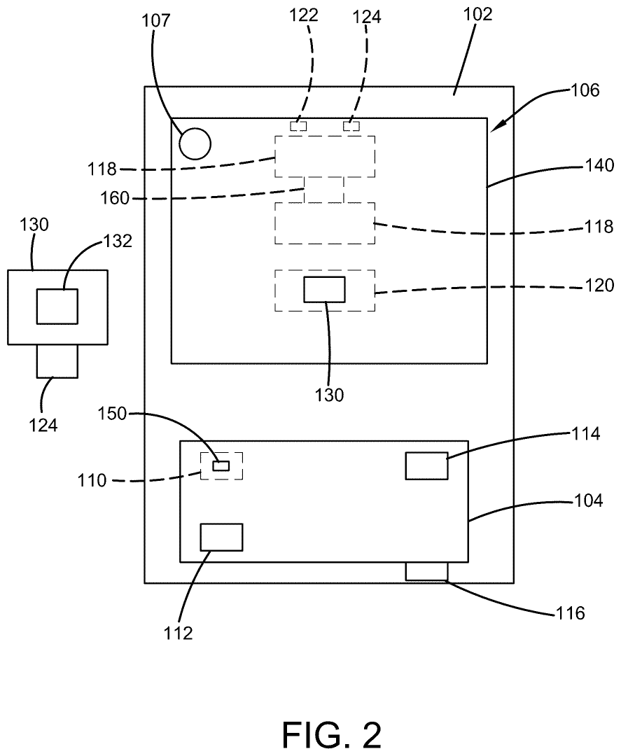

The air tank 104 is preferably a five-gallon aluminum tank designed to store and supply a consistent flow of pressurized air to connected tools. The tank 104 is comprised of a pressure regulator 110 that allows for the adjustment of air pressure based on tool requirements, as seen in FIG. 2. The regulator 110 may be manually adjustable via a control 150 such as but not limited to a rotary dial. The tank 104 is further comprised of a quick-connect fitting 112, such as but not limited to a universal pneumatic coupler, that enables the rapid attachment or detachment of air hoses with minimal effort. The quick-connect fitting 112 may be spring-loaded to ensure a secure connection and prevent accidental hose detachment. A front-facing pressure gauge 114 (as seen in FIG. 2) provides a visual indication of current air pressure, wherein the gauge 114 may be digital or analog. The digital version of the gauge 114 may be an LED or LCD display with backlighting for improved visibility in low-light conditions. To prevent moisture accumulation inside the tank 104, a bottom-mounted condensation drain plug 116 facilitates water drainage, reducing the risk of internal corrosion and extending the operational lifespan of the device 100.

The compressor assembly 106 is fluidly connected to the tank 104 and may be comprised of a dual-stage compression mechanism 118 (as seen in FIG. 2) that enhances airflow efficiency while maintaining stable operating pressure. The dual-stage compression mechanism 118 may include an intercooler 160 to dissipate heat between compression stages, improving efficiency and reducing wear on internal components. The compressor assembly 106 is further comprised of a low-noise motor 120 that minimizes sound output, making the device 100 suitable for indoor environments and prolonged use in noise-sensitive areas. An automatic on/off pressure switch 122 may activate or deactivate the compressor assembly 106 based on pre-set pressure thresholds, ensuring optimal energy consumption. Additionally, an automatic pressure cut-off mechanism 124 may stop the compressor operation when maximum pressure is reached, preventing over-pressurization and conserving battery power. The compressor assembly 106 is enclosed within a waterproof housing 140, which protects internal components from exposure to moisture, dust, and other environmental contaminants. The waterproof housing 140 may be made of impact-resistant polymer or a composite material to provide additional durability. The housing 140 may also feature strategically placed vents or passive cooling elements to prevent overheating while maintaining water resistance.

The device 100 is powered by at least one removable high-capacity lithium-ion battery pack 130 (as seen in FIG. 2), which supplies energy to the compressor assembly 106. The battery pack 130 is comprised of a battery status indicator 132 that provides real-time feedback on remaining charge levels, allowing the user to monitor power availability and perform timely battery replacements. The battery status indicator 132 may utilize a multi-LED system to indicate different charge levels or may include a numerical display for precise percentage readings. The battery pack 130 is also comprised of a charging port 134, such as but not limited to a standard DC charging interface, to enable efficient recharging.

As a result, the back-worn air compressor device 100 enhances workplace efficiency and safety by eliminating the need for cumbersome extension cords and stationary air compressors. The combination of a wearable design, efficient power management, and advanced safety features makes the device 100 a practical solution for professionals who require a portable and reliable compressed air supply.

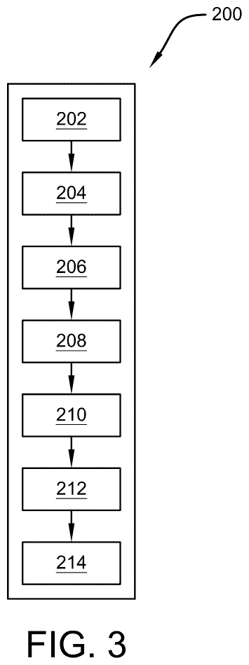

The present invention is also comprised of a method of using the back-worn air compressor device 100, as seen in FIG. 3. First, a device 100 is provided, comprised of a frame 102 supporting at least one air tank 104 and at least one compressor assembly 106 [Step 202]. Then, the user secures the device 100 onto their back using the adjustable harness system 108 and, if desired, the optional waist belt 111 for additional stability [Step 204]. Next, the user connects a pneumatic tool to the quick-connect fitting 112 [Step 206]. The user may then adjust the output pressure of the air tank 104 via the pressure regulator 110 to match the tool's operational requirements [Step 208]. Once connected, the user activates the compressor assembly 106 via a button 107 (or other similar control), which will automatically regulate air compression based on pre-set pressure thresholds via the automatic on/off pressure switch 122 [Step 210]. The user can replace or recharge the removable lithium-ion battery pack 130 via the charging port 134 as needed [Step 212]. Finally, after use, the user may open the bottom-mounted condensation drain plug 116 to remove accumulated moisture from the air tank 104 [Step 214].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “back-worn air compressor device” and “device” are interchangeable and refer to the back-worn air compressor device 100 of the present invention.

Notwithstanding the forgoing, the back-worn air compressor device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the back-worn air compressor device 100 as shown in the FIGS. are for illustrative purposes only, and that many other sizes and shapes of the back-worn air compressor device 100 are well within the scope of the present disclosure. Although the dimensions of the back-worn air compressor device 100 are important design parameters for user convenience, the back-worn air compressor device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A back-worn air compressor device comprising:
a frame;
a harness system coupled to the frame and configured to secure the frame to a user;
an air tank supported by the frame;
a compressor assembly supported by the frame and fluidly connected to the air tank; and
a battery pack electrically connected to the compressor assembly, wherein the battery pack powers the compressor assembly.

2. The back-worn air compressor device of claim 1, wherein the harness system is further comprised of a waist belt.

3. The back-worn air compressor device of claim 1, wherein the frame is comprised of an airflow channel.

4. The back-worn air compressor device of claim 1, wherein the air tank is comprised of a condensation drain plug.

5. The back-worn air compressor device of claim 1, wherein the compressor assembly is comprised of a dual-stage compression mechanism.

6. The back-worn air compressor device of claim 5 further comprised of an intercooler.

7. The back-worn air compressor device of claim 1 further comprised of a motor.

8. The back-worn air compressor device of claim 1, wherein the compressor assembly is positioned within a waterproof housing.

9. A back-worn air compressor device comprising:
a frame;
a harness system coupled to the frame and configured to secure the frame to a user, wherein the harness system is comprised of a shoulder strap;
an air tank supported by the frame, the air tank comprised of a pressure regulator and a quick-connect fitting;
a compressor assembly supported by the frame and fluidly connected to the air tank; and
a battery pack removably connected to the compressor assembly, wherein the battery pack powers the compressor assembly.

10. The back-worn air compressor device of claim 9, wherein the battery pack is comprised of a charging port.

11. The back-worn air compressor device of claim 9, wherein the battery pack is comprised of a status indicator.

12. The back-worn air compressor device of claim 9 further comprised of a pressure gauge.

13. The back-worn air compressor device of claim 12, wherein the pressure gauge is a digital pressure gauge.

14. The back-worn air compressor device of claim 9 further comprised of a button.

15. The back-worn air compressor device of claim 9 further comprised of a waist belt.

16. The back-worn air compressor device of claim 9 further comprised of an automatic on/off pressure switch.

17. The back-worn air compressor device of claim 9 further comprised of a pressure gauge.

18. The back-worn air compressor device of claim 9, wherein the compressor assembly is comprised of a dual-stage compression mechanism.

19. The back-worn air compressor device of claim 18 further comprised of an intercooler.

20. A method of using a back-worn air compressor device, the method comprising:
providing a back-worn air compressor device comprised of a frame, an air tank, a compressor assembly, a harness system, and a battery pack;
securing the back-worn air compressor device onto a user's back using the harness system;
connecting a pneumatic tool to a quick-connect fitting of the air tank;
adjusting an output pressure of air tank via a pressure regulator;
activating the compressor assembly to regulate air compression based on a pre-set pressure threshold; and
recharging or replacing the battery pack as needed.
